(19) United States
(12) Patent Application Publication
(10) Pub. No.: US 2026/0296337 A1
(43) Pub. Date: Oct. 1, 2026

(54) VEHICLE

(71) Applicant: TOYOTA JIDOSHA KABUSHIKI KAISHA, Toyota-shi (JP)

(72) Inventor: Toshinori OKI, Toyota-shi (JP)

(21) Appl. No.: 19/403,242

(22) Filed: Nov. 28, 2025

(30) Foreign Application Priority Data
Mar. 31, 2025 (JP) 2025-059076

(51) Int. Cl. B60R 16/02; B60R 16/08

(52) U.S. Cl. CPC B60R 16/0215; B60R 16/08

(57) ABSTRACT

A vehicle includes an engine provided with a forced-induction device. The engine includes an exhaust passage, a catalyst device having a substrate that supports a catalyst and configured such that the substrate generates heat when the substrate is energized, and a turbocharger including a turbine. The catalyst device and the turbine are disposed in the exhaust passage. The vehicle further includes a power supply, a cable that connects the power supply to the catalyst device and configured to supply electricity from the power supply to the substrate, a pipe for refrigerant that cools the turbocharger, and an engine compartment. The engine, power supply, cable, and pipe are disposed in the engine compartment. An intermediate portion of the cable is fixed to the pipe along the pipe.

### CROSS-REFERENCE TO RELATED APPLICATIONS

This application is based upon and claims the benefit of priority from Japanese Patent Application No. 2025-059076, filed on Mar. 31, 2025, the entire contents of which are incorporated herein by reference.

### BACKGROUND

### 1. Field

The present disclosure relates to a vehicle.

### 2. Description of Related Art

JPH09-032533A discloses a structure of an exhaust gas purification device for purifying exhaust gas from an engine. This exhaust purification device has a catalyst carrier provided with two electrode terminals, and the catalyst carrier generates heat by being energized via these electrode terminals. A power supply is connected to the electrode terminals via a cable.

The exhaust purification device of the above-mentioned publication has a relay terminal and a relay cable for relaying the connection between the cable and the electrode terminal of the catalyst carrier. In this exhaust purification device, by providing the relay terminal and the relay cable, the heat transfer path from the electrode terminal of the catalyst carrier to the cable is extended. In this way, the exhaust purification device suppresses thermal deterioration of the cable due to overheating.

Each exhaust system component constituting the exhaust passage is heated to a high temperature by the heat of the exhaust gas flowing therethrough. The cable may also be thermally degraded by heat from the exhaust system components.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A vehicle according to an aspect of the present disclosure includes an engine provided with a forced-induction device. The engine includes an exhaust passage, a catalyst device having a substrate that supports a catalyst and configured such that the substrate generates heat when the substrate is energized, and a turbocharger including a turbine. The catalyst device and the turbine are disposed in the exhaust passage. The vehicle further includes a power supply, a cable that connects the power supply to the catalyst device and configured to supply electricity from the power supply to the substrate, a pipe for refrigerant that cools the turbocharger, and an engine compartment. The engine, the power supply, the cable, and the pipe are disposed in the engine compartment. An intermediate portion of the cable is fixed to the pipe so as to extend along the pipe.

Other features and aspects will be apparent from the following detailed description, the drawings, and the claims.

### BRIEF DESCRIPTION OF THE DRAWINGS

FIG. 1 is a top view schematically showing a configuration of a vehicle equipped with an engine including an electrically heated catalyst and a turbocharger.

FIG. 2 is a right side view of the interior of the engine compartment of the vehicle of FIG. 1;

FIG. 3 is a cross-sectional view showing the structure of the turbocharger shown in FIG. 1.

FIG. 4 is a cross-sectional view showing the structure of the electrically heated catalyst of FIG. 1.

FIG. 5 is a cross-sectional view of the fixing portion taken along line 5-5 of FIG. 2.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

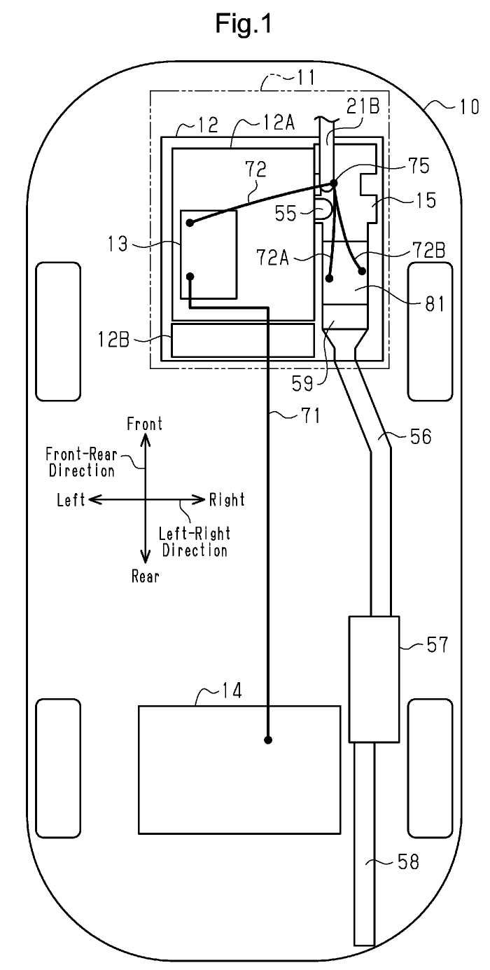

Hereinafter, a vehicle 10, which is an embodiment of a vehicle according to the present disclosure, will be described with reference to FIGS. 1 to 5.

### Configuration of Vehicle 10

As shown in FIG. 1, an engine compartment 11 is provided in a front portion of the vehicle 10 as indicated by the two-dot chain line. A hybrid mechanism 12 is mounted in the engine compartment 11. The hybrid mechanism 12 includes an engine 12A and a motor generator 12B. The motor generator 12B is an electric motor used as both a power generator and a rotating machine.

A converter 13 is disposed above the engine 12A. The converter 13 is connected to the battery 14 through a battery cable 71. The converter 13 and the battery 14 exchange electricity through a battery cable 71. The battery 14 is, for example, a lithium ion battery. The battery 14 is disposed at the same position as the rear wheel of the vehicle 10 in the front-rear direction.

The converter 13 converts a voltage and a current of electricity supplied from the battery 14. The converter 13 is, for example, an in-vehicle charger. The converter 13 is a power supply that supplies electricity to electric devices mounted on the vehicle 10. The converter 13 converts a voltage of a direct current supplied from the battery 14, and supplies the converted voltage to an electric device. The converter 13 converts a direct current supplied from the battery 14 into an alternating current and supplies the alternating current to the motor generator 12B. The converter 13 converts an alternating current generated by the motor generator 12B into a direct current and charges the battery 14 with the direct current.

An electrically heated catalyst 81 and a turbocharger 15 are provided on the right side of the engine 12A. As shown in FIG. 1, the right side and the left side of the vehicle 10 are defined with reference to a state in which the driver is facing forward. The electrically heated catalyst 81 is a catalyst device that purifies exhaust gas from the engine 12A. The turbocharger 15 is a forced-induction device including a compressor 30 and a turbine 50, which will be described later.

### Configuration of Exhaust Passage

The exhaust gas of the engine 12A flows through the exhaust system components of the exhaust passage, and is discharged from the vehicle 10. The exhaust system components include an exhaust manifold 55, the turbine 50 of the turbocharger 15, the electrically heated catalyst 81, an exhaust pipe 56, the muffler 57, a tail pipe 58, and a connector 59. The exhaust manifold 55, the turbine 50, the electrically heated catalyst 81, the connector 59, the exhaust pipe 56, the muffler 57, and the tail pipe 58 are connected in this order from the upstream side closer to the engine 12A. The exhaust gas from the engine 12A is discharged from the downstream end of the tail pipe 58 to the outside of the vehicle 10.

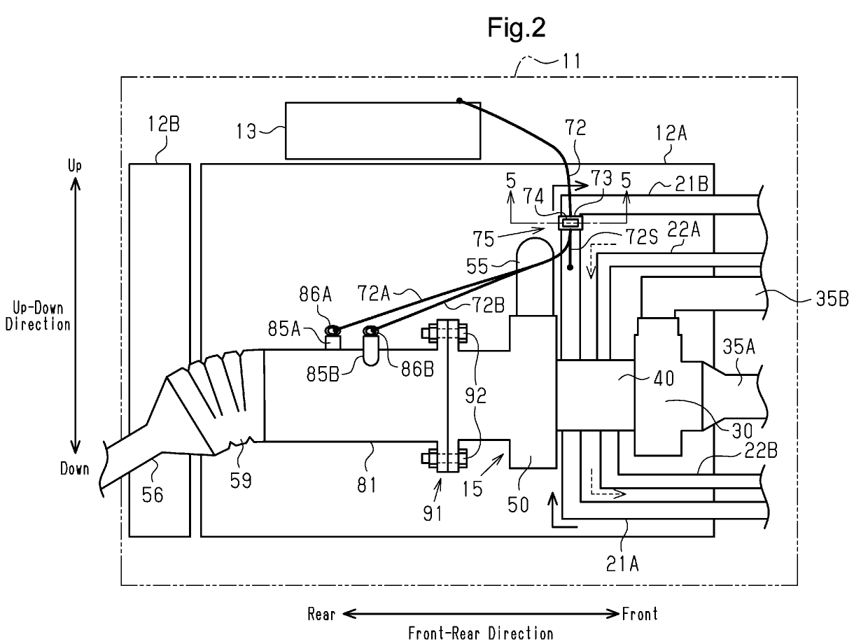

FIG. 2 is a right side view of the interior of the engine compartment 11. As shown in FIGS. 1 and 2, the electrically heated catalyst 81 and the exhaust pipe 56 are connected to each other via the connector 59. The connector 59 is an exhaust pipe provided with a bellows portion. When the relative position between the exhaust system components changes due to vibration or torsion of the body of the vehicle 10, the change in the relative position is allowed by deformation of the bellows portion of the connector 59. For example, when the distance between the electrically heated catalyst 81 and the exhaust pipe 56 increases, the bellows portion of the connector 59 is deformed so as to extend.

The turbocharger 15 and the electrically heated catalyst 81 are disposed on the right side of the engine 12A. More specifically, the turbocharger 15 is disposed at a position corresponding to the right side of the engine 12A and a front portion of the engine 12A. The electrically heated catalyst 81 is disposed at a position corresponding to the right side of the engine 12A and a rear portion of the engine 12A.

As described above, the electrically heated catalyst 81 and the turbine 50 are disposed in the exhaust passage of the engine 12A. The electrically heated catalyst 81 and the turbocharger 15 are located beside the engine 12A.

The turbocharger 15 and the electrically heated catalyst 81 are connected to each other at a fastening portion 91. At the fastening portion 91, the downstream end of the turbocharger 15 and the upstream end of the electrically heated catalyst 81 are fixed to each other using fastening components 92. Examples of the fastening components 92 include bolts and nuts. The turbocharger 15 and the electrically heated catalyst 81 are directly fixed to each other using the fastening components 92 without a structure that allows relative movement, such as the connector 59. Fixing without a structure that allows relative movement is referred to as rigid fixing.

### Configuration of Turbocharger 15

As shown in FIG. 2, the turbocharger 15 includes a turbine 50, a compressor 30, and a bearing portion 40. The turbine 50 and the compressor 30 are coupled to each other via the bearing portion 40. The turbocharger 15 is mounted on the vehicle 10 such that the turbine 50 is located rearward of the compressor 30, with the turbocharger 15 mounted on the vehicle 10.

A first intake passage 35A and a second intake passage 35B are connected to the compressor 30. Intake air in the vehicle 10 flows into the compressor 30 from the first intake passage 35A. After passing through the compressor 30, the intake air flows into the second intake passage 35B. The intake air is cooled by an intercooler provided in the second intake passage 35B, and is introduced into the engine 12A.

Specifically, the first intake passage 35A is connected to the upstream side of the compressor 30. The second intake passage 35B is connected to the downstream side of the compressor 30. As described above, the exhaust manifold 55 is connected to the upstream side of the turbine 50. The electrically heated catalyst 81 is connected to the downstream side of the turbine 50.

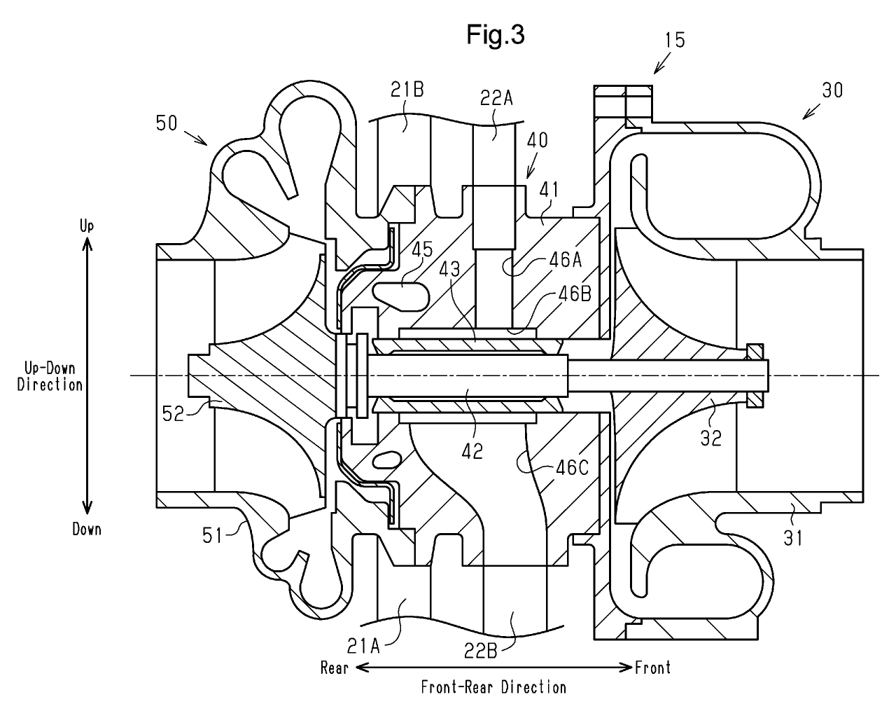

FIG. 3 is a cross-sectional view showing the structure of the turbocharger 15. FIG. 3 is a cross-sectional view of the turbocharger 15 mounted on the vehicle 10, taken along a plane along the front-rear direction and the up-down direction.

As shown in FIG. 3, the turbine 50 includes a turbine housing 51 that accommodates a turbine impeller 52. The compressor 30 includes a compressor housing 31 that accommodates a compressor impeller 32. The bearing portion 40 includes a bearing housing 41 through which a turbine shaft 42 is inserted. The turbine shaft 42 is supported by the bearing housing 41 via a bearing 43. The turbine impeller 52 is fixed to the first end of the turbine shaft 42. The compressor impeller 32 is fixed to the second end of the turbine shaft 42. When the turbine impeller 52 rotates, the turbine shaft 42 and the compressor impeller 32 rotate together with the turbine impeller 52.

The exhaust gas flowing from the engine 12A into the exhaust manifold 55 passes through the turbine 50 and into the electrically heated catalyst 81. In this process, the turbine impeller 52 is rotated by the energy of the exhaust gas flowing into the turbine 50. Then, the compressor impeller 32 rotates integrally with the rotation of the turbine impeller 52. The compressor impeller 32 compresses the intake air flowing into the compressor 30 from the first intake passage 35A by the rotational energy, and delivers the intake air to the second intake passage 35B.

As shown in FIGS. 2 and 3, the bearing housing 41 is connected to four pipes. Coolant and lubricating oil, which are refrigerant for cooling the turbocharger 15, flow through the four pipes.

As shown in FIG. 2, the pipes through which coolant flows are a first cooling pipe 21A and a second cooling pipe 21B. The first cooling pipe 21A and the second cooling pipe 21B are made of metal. Coolant is delivered by a water pump (not shown) to flow through the cooling pipes and the turbocharger 15 in a direction indicated by the solid arrow in FIG. 2. The first cooling pipe 21A supplies coolant to the turbocharger 15. The second cooling pipe 21B causes coolant to return from the turbocharger 15 to the radiator.

As shown in FIG. 3, the coolant supplied to the turbocharger 15 through the first cooling pipe 21A flows inside a water jacket 45, which is provided in the bearing housing 41. The coolant cools the bearing housing 41, thereby cooling the turbocharger 15.

As shown in FIG. 2, the pipes through which the lubricant flows are a first lubrication pipe 22A and a second lubrication pipe 22B. Lubricating oil is delivered by an oil pump (not shown) so as to flow through the lubricating pipes and the turbocharger 15 in a direction indicated by the broken arrow in FIG. 2. The first lubrication pipe 22A supplies the lubricating oil to the turbocharger 15. The second lubrication pipe 22B causes the lubricating oil to return from the turbocharger 15 to the oil cooler.

As shown in FIG. 3, the lubricating oil supplied to the turbocharger 15 through the first lubrication pipe 22A flows inside a first oil passage 46A, a second oil passage 46B, and a third oil passage 46C provided in the bearing housing 41. The lubricant oil cools the bearing housing 41 while passing through the bearing housing 41 in the order of the first oil passage 46A, the second oil passage 46B, and the third oil passage 46C. In addition, the lubricant flowing through the first oil passage 46A through the second oil passage 46B lubricates the bearing 43 and the turbine shaft 42. As described above, the lubricating oil cools and lubricates the turbocharger 15.

### Connection of Power Cable 72 to Electrically Heated Catalyst 81

As shown in FIGS. 1 and 2, the electrically heated catalyst 81 is connected to the converter 13 via the power cable 72. The first end of the power cable 72 is connected to a power supply terminal of the converter 13. The second end of the power cable 72 is connected to the electrically heated catalyst 81. The power cable 72 branches into two cables, namely, a first cable 72A and a second cable 72B, on the side closer to its second end. The power cable 72 supplies electricity from the converter 13 to the electrically heated catalyst 81.

As shown in FIG. 2, the electrically heated catalyst 81 is provided with a first terminal portion 85A and a second terminal portion 85B. A first terminal 86A and a second terminal 86B are provided at the tips of the first terminal portion 85A and the second terminal portion 85B, respectively. The first cable 72A is connected to the first terminal 86A. The second cable 72B is connected to the second terminal 86B.

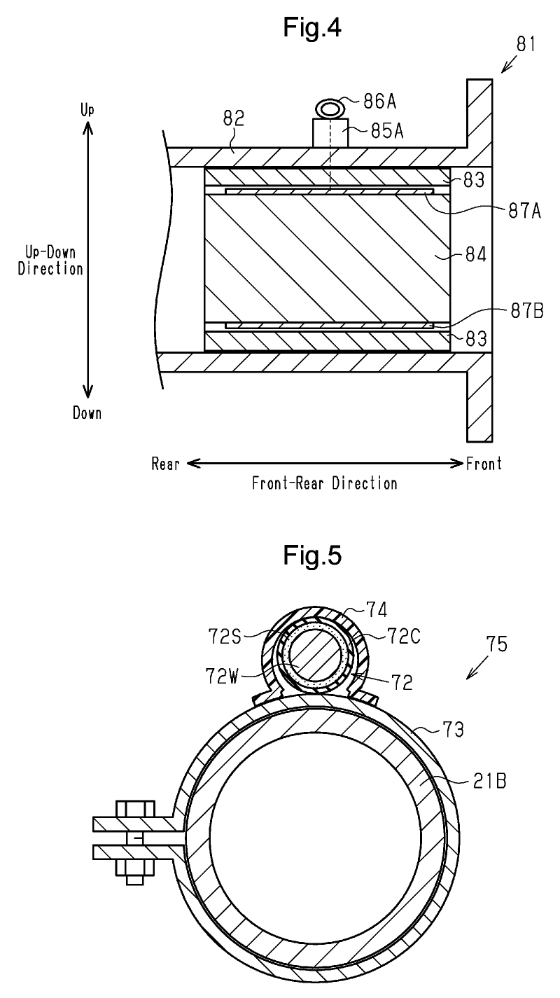

FIG. 4 is a cross-sectional view showing the structure of the electrically heated catalyst 81. FIG. 4 is a cross-sectional view of the electrically heated catalyst 81, mounted on the vehicle 10 with a specific orientation taken along a plane defined by front-rear direction and the up-down direction.

As shown in FIG. 4, the electrically heated catalyst 81 includes a case 82. The case 82 of the electrically heated catalyst 81 accommodates a mat member 83, a catalyst carrier 84, a first electrode 87A, and a second electrode 87B. The catalyst carrier 84 is cylindrical. The catalyst carrier 84 has a mesh structure, with its interior divided into multiple passages extending in the direction of exhaust gas flow. The catalyst carrier 84 supports a catalyst. Examples of the supported catalyst include a three-way catalyst. The catalyst carrier 84 is a substrate that carries a catalyst. The catalyst carrier 84 is formed of a material (e.g., silicon carbide) that generates heat upon energization.

A mat member 83 is disposed outside the catalyst carrier 84. The mat member 83 supports the catalyst carrier 84 in the case 82 by filling a gap between the catalyst carrier 84 and the case 82. A first electrode 87A and a second electrode 87B are provided between the mat member 83 and the catalyst carrier 84. The first electrode 87A is electrically connected to the first terminal portion 85A via lead wires passing through the first terminal 86A, which are indicated by the broken line in FIG. 4. The second electrode 87B is electrically connected to the second terminal portion 85B via lead wires passing through the second terminal 86B. The first electrode 87A and the second electrode 87B are thin metal plates having a comb-like shape. The first electrode 87A and the second electrode 87B are provided along a cylindrical outer surface of the catalyst carrier 84, so that the first electrodes 87A and the second electrodes 87B are connected to the catalyst carrier 84.

The catalyst carrier 84 is connected to the converter 13 through a circuit formed by a first portion including the power cable 72, the first cable 72A, the first terminal 86A, and the first electrode 87A, and a second portion including the power cable 72, the second cable 72B, the second terminal 86B, and the second electrode 87B. Electricity from the converter 13 is supplied to the catalyst carrier 84 through the circuit.

### Fixing of Power Cable 72

As shown in FIGS. 1 and 2, an intermediate portion of the power cable 72 is fixed to the second cooling pipe 21B at a fixing portion 75 so as to extend along the second cooling pipe 21B. As shown in FIG. 2, the fixing portion 75 is located above the electrically heated catalyst 81 and the turbocharger 15.

FIG. 5 is a cross-sectional view of the fixing portion 75 taken along a line 5-5 indicated by the single-dashed line in FIG. 2, as seen from below. As shown in FIG. 5, a metal bracket 73 is attached to the outer side of the second cooling pipe 21B in the fixing portion 75. For example, the bracket 73 is fixed to the second cooling pipe 21B by fastening opposite ends of the bracket 73 with bolts and nuts.

The power cable 72 is fixed to the bracket 73 using a fastener 74. The fastener 74 is made of resin. The power cable 72 is fixed to the second cooling pipe 21B using the fastener 74 at a position between a point at which the power cable 72 branches into two and the first end connected to the converter 13.

As shown in FIG. 5, the power cable 72 includes a covering portion 72C, a shield wire 72S, and a core wire 72W. The covering portion 72C is an insulating body, and covers the core wire 72W and the shield wire 72S. The covering portion 72C is made of, for example, silicone. The covering portion 72C is made of, for example, rubber. The covering portion 72C protects the core wire 72W and the shield wire 72S from damage.

The power cable 72 is structured such that the shield wire 72S surrounds the core wire 72W through which power from the converter 13 flows. The shield wire 72S shields electromagnetic waves generated by the electricity flowing through the core wire 72W.

To shield the electromagnetic waves generated by the core wire 72W using the shield wire 72S, it is preferrable to set the ground for dissipating the current generated in the shield wire 72S.

As shown in FIG. 2, the shield wire 72S branches from the power cable 72 at its portion between the fixing portion 75 and the second end of the power cable 72, which is connected to the electrically heated catalyst 81. The end of the branched shield wire 72S is connected to the second cooling pipe 21B. That is, the shield wire 72S uses the metal second cooling pipe 21B as the ground. The shield wire 72S is grounded by being connected to the second cooling pipe 21B.

As shown in FIGS. 1 and 2, the converter 13, the power cable 72, and the second cooling pipe 21B are all disposed in the engine compartment 11.

### Operation of the Present Embodiment

The power cable 72, which connects the electrically heated catalyst 81 to the converter 13, is shaken by vibration of the vehicle 10. When the power cable 72 swings, the power cable 72 is likely to contact or interfere with surrounding components such as those of the engine 12A and those of the exhaust passage. When the power cable 72 comes into contact with or interferes with surrounding components, the power cable 72 may be damaged. If the power cable 72 is fixed to surrounding components, such damage to the power cable 72 is limited.

Exhaust system components such as the exhaust manifold 55, the turbocharger 15, and the electrically heated catalyst 81, which are components of the exhaust passage, have a relatively high temperature because high-temperature exhaust gas flows therethrough. Accordingly, when the power cable 72 is fixed to these exhaust system components, the power cable 72 is likely to be thermally deteriorated by heat from the exhaust system components.

In the vehicle 10 according to the present embodiment, the power cable 72 is fixed to the second cooling pipe 21B through which the coolant for cooling the turbocharger 15 flows. The temperature of the coolant that cools the turbocharger 15 is lower than that of the exhaust gas. Thus, the temperature of the second cooling pipe 21B is maintained to be lower than the temperatures of the exhaust system components. In the present embodiment, the power cable 72 is fixed to the second cooling pipe 21B, which has a relatively low temperature.

### Advantages of the Present Embodiment

(1) The above configuration limits damage to the power cable 72 that would result from the contact or interference with surrounding components and limits deterioration of the power cable 72 that would result from heat.

(2) The upstream end of the electrically heated catalyst 81 is rigidly fixed to the downstream end of the turbocharger 15.

The exhaust pipe of the exhaust passage typically includes a buffer such as a bellows pipe or a ball joint that connects components of the exhaust passage to each other to absorb bending stress caused by vibration. As shown in FIG. 2, for example, the connector 59 with the bellows portion is connected between the electrically heated catalyst 81 and the exhaust pipe 56.

When the electrically heated catalyst 81 and the turbocharger 15 are rigidly fixed to each other, the relative position between the electrically heated catalyst 81 and the turbocharger 15 is less likely to change than when the electrically heated catalyst 81 and the turbocharger 15 are connected to each other via a buffer.

In the present embodiment, relative movement of the first terminal 86A and the second terminal 86B, which are connecting portions between the electrically heated catalyst 81 and the power cable 72, and relative movement of the fixing portion 75 of the power cable 72 with respect to the second cooling pipe 21B are relatively small. When the relative movement between the portions to which the power cable 72 is fixed is relatively large, the power cable 72 largely vibrates, and the contact or interference with surrounding components is likely to occur. When the power cable 72 comes into contact with or interferes with surrounding components, the power cable 72 may be damaged.

The present embodiment reduces damage to the power cable 72.

(3) The second cooling pipe 21B is made of metal. The power cable 72 includes the shield wire 72S for shielding electromagnetic waves. The shield wire 72S is grounded by being connected to the second cooling pipe 21B.

The second cooling pipe 21B is used as the ground of the shield wire 72S of the power cable 72. Utilizing the second cooling pipe 21B as the ground reduces noise that would result from electromagnetic waves generated by the power cable 72.

(4) The converter 13 is disposed on the engine 12A. The electrically heated catalyst 81 and the turbocharger 15 are arranged beside the engine 12A. The power cable 72 is fixed to the second cooling pipe 21B at a position above the electrically heated catalyst 81 and the turbocharger 15.

The converter 13 and the fixing portion 75, at which the power cable 72 is fixed to the second cooling pipe 21B, are located above the electrically heated catalyst 81 and the turbocharger 15, which are located beside the engine 12A.

The present preferred embodiment provides easier access to the engine compartment 11 from above, thereby facilitating work of removing the power cable 72 from the converter 13 and connecting the power cable 72 to the converter 13.

For example, when maintenance of the vehicle 10 is performed, it is desirable to remove the power cable 72, which supplies electricity to the electrically heated catalyst 81, from the converter 13 in order to prevent electric shock to an operator. The operator is enabled to remove the power cable 72 from the power supply terminal of the converter 13 by extending his hand from above the engine compartment 11. Then, when the maintenance of the vehicle 10 is completed, the operator is enabled to extend his hand from above the engine compartment 11 and attach the power cable 72 to the power supply terminal of the converter 13. The present embodiment facilitates the maintenance work of the vehicle 10 as described above.

### Modifications

The present embodiment may be modified as follows. The present embodiment and the following modifications can be combined as long as the combined modifications remain technically consistent with each other.

In the above embodiment, the power cable 72 is fixed to the second cooling pipe 21B, which causes coolant to return to the radiator. The power cable 72 may be fixed to the first cooling pipe 21A, which supplies coolant to the turbocharger 15.

The modification achieves the above-described advantages (1) to (3). Additionally, in a vehicle in which the arrangement of the cooling pipes is different from that in the vehicle 10 of the above-described embodiment, when the power cable 72 is fixed to the first cooling pipe 21A at a position above the electrically heated catalyst 81 and the turbocharger 15, the above-described advantage (4) is achieved.

In the above embodiment, the power cable 72 is fixed to the second cooling pipe 21B, which causes coolant to return to the radiator. The pipe to which the power cable 72 is fixed may be the first lubrication pipe 22A or the second lubrication pipe 22B through which lubricating oil flows.

The power cable 72 does not have to be fixed at one position. The power cable 72 may be fixed to the second cooling pipe 21B at two or more positions. Alternatively, the power cable 72 may be fixed to one or more of the first cooling pipe 21A, the second cooling pipe 21B, the first lubrication pipe 22A, and the second lubrication pipe 22B at two or more positions in total. For example, the power cable 72 may be fixed to each of the second cooling pipe 21B and the first lubrication pipe 22A.

The vehicle 10 is a hybrid vehicle on which a hybrid mechanism 12 is mounted. The vehicle 10 may be a vehicle on which only an engine is mounted. In this case, the converter 13 may be a DC-DC converter that converts the voltage of direct current from the battery 14.

The electrically heated catalyst 81 and the turbocharger 15 do not have to be disposed on the right side of the engine 12A. The electrically heated catalyst 81 and the turbocharger 15 may be disposed at any of the front, left, and rear of the engine 12A.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle, comprising:
an engine provided with a forced-induction device, the engine including an exhaust passage, a catalyst device having a substrate that supports a catalyst and configured such that the substrate generates heat when the substrate is energized, and a turbocharger including a turbine, and the catalyst device and the turbine being disposed in the exhaust passage;
a power supply;
a cable that connects the power supply to the catalyst device, the cable configured to supply electricity from the power supply to the substrate;
a pipe for refrigerant that cools the turbocharger; and
an engine compartment, wherein
the engine, the power supply, the cable, and the pipe are disposed in the engine compartment, and
an intermediate portion of the cable is fixed to the pipe so as to extend along the pipe.

2. The vehicle according to claim 1, wherein
an upstream end of the catalyst device is rigidly fixed to a downstream end of the turbocharger.

3. The vehicle according to claim 1, wherein
the pipe is made of metal, and
the cable includes a shield wire configured to shield an electromagnetic wave, the shield wire being grounded by being connected to the pipe.

4. The vehicle according to claim 1, wherein
the power supply is disposed on the engine,
the catalyst device and the turbocharger are located beside the engine, and
the cable is fixed to the pipe at a position above the catalyst device and the turbocharger.

5. The vehicle according to claim 1, wherein
the pipe is configured such that coolant for cooling the turbocharger flows through the pipe.
